(19) United States
(12) Patent Application Publication
(10) Pub. No.: US 2017/0131885 A1
(43) Pub. Date: May 11, 2017

(54) IMAGE RETRIEVAL CONDITION SETTING DEVICE, IMAGE RETRIEVAL CONDITION SETTING METHOD, IMAGE RETRIEVAL APPARATUS, IMAGE RETRIEVAL METHOD, PROGRAM, AND RECORDING MEDIUM

(71) Applicant: FUJIFILM Corporation, Tokyo (JP)

(72) Inventor: Masato YAMAMOTO, Tokyo (JP)

(73) Assignee: FUJIFILM Corporation, Tokyo (JP)

(21) Appl. No.: 15/332,011

(22) Filed: Oct. 24, 2016

(30) Foreign Application Priority Data
Nov. 6, 2015 (JP) 2015-218196

(51) Int. Cl. G06F 3/0484; G06T 1/00

(52) U.S. Cl. CPC G06F 3/04847; G06T 1/0007; G06F 3/04842; G06T 2200/24; G06F 3/0488

(57) ABSTRACT

In the image retrieval condition setting device, a numerical value range determination unit determines, with respect to at least one of plural retrieval conditions for retrieving an image from plural images, a numerical value range of the retrieval condition according to the plural images. A display control unit displays a slide region indicating the numerical value range of the retrieval condition on the display unit and displays a button region that moves on the slide region on the display unit according to an instruction of a user, for each retrieval condition. Further, a numerical value setting unit sets a numerical value corresponding to the position of the button region on the slide region from the numerical value range of the retrieval condition as the numerical value of the retrieval condition, for each retrieval condition.

### CROSS-REFERENCE TO RELATED APPLICATIONS

The present application claims priority under 35 U.S.C. §119 to Japanese Patent Application No. 2015-218196, filed on Nov. 6, 2015, all of which are hereby expressly incorporated by reference into the present application.

### BACKGROUND OF THE INVENTION

1. Field of the Invention

The present invention relates to an image retrieval condition setting device and an image retrieval condition setting method for setting numerical values of plural retrieval conditions, an image retrieval apparatus and an image retrieval method for retrieving an image that matches numerical values of plural retrieval conditions from plural images, and a program and a recording medium.

2. Description of the Related Art

In a smart phone, there is a case where a large number of images (photos), for example, several hundreds or thousands of images (photos) captured by a camera function thereof are stored. However, in many cases, such a large number of images are not effectively used.

For example, when the number of images stored in a smart phone becomes large, a user may not easily remember which images are stored or where a certain image is stored.

Further, on a display screen of a smart phone, only about 16 thumbnail images can be displayed at a time. Thus, it is considerably difficult for a user to search for a desired image from a large number of images while checking contents of images.

On the other hand, among applications that operate in a smart phone and create an electronic album or the like, there is an application having a function of retrieving a user's desired image from a large number of images according to numerical values of retrieval conditions. However, since such an application does not have sufficient functions, it is still difficult for a user to search for a desired image.

Accordingly, in order to allow a user to easily use images, for example, to arrange, share, or print images, it is desirable to enhance operability when retrieving a user's desired image from a large number of images.

In this regard, JP2013-178602A discloses a retrieval technique in which retrieval axes of plural types of retrieval items are displayed on a point input screen and a user moves a marker on each retrieval axis in a transverse direction to input a point for a retrieval item according to a position on the retrieval axis.

However, in the retrieval technique disclosed in JP2013-178602A, numerical values in a predetermined numerical value range, for example, numerical values of −5 to 5 are defined with respect to the retrieval axes of all the retrieval items from the beginning, and the numerical value range is not necessarily changed according to the types of retrieval items. In other words, the retrieval technique disclosed in JP2013-178602A can be applied to only retrieval items in which it is not necessary that a numerical value range thereof is changed, and cannot be applied to retrieval items of types in which a numerical value range thereof is changed according to retrieval targets.

### SUMMARY OF THE INVENTION

In order to solve the above-mentioned problems in the related art, an object of the invention is to provide an image retrieval condition setting device and an image retrieval condition setting method capable of setting numerical values of plural retrieval conditions of types in which a numerical value range thereof is changed according to plural images which are retrieval targets, an image retrieval apparatus and an image retrieval method capable of retrieving an image that matches numerical values of plural retrieval conditions from plural images, and a program and a recording medium.

According to an aspect of the invention, there is provided an image retrieval condition setting device comprising: a display unit; an instruction acquisition unit that acquires an instruction input by a user; a numerical value range determination unit that determines, with respect to at least one of a plurality of retrieval conditions for retrieving an image from a plurality of images, a numerical value range of the retrieval condition according to the plurality of images; a display control unit that displays a slide region indicating the numerical value range of the retrieval condition on the display unit and displays a button region that moves on the slide region on the display unit according to an instruction of the user, for each retrieval condition; and a numerical value setting unit that sets a numerical value corresponding to the position of the button region on the slide region from the numerical value range of the retrieval condition as the numerical value of the retrieval condition, for each retrieval condition.

Here, it is preferable that the display control unit displays the button region on the display unit that changing the size of the button region as the button region moves on the slide region.

It is preferable that the display control unit displays the button region on the display unit that changing the size of the button region so that the size of the button region is gradually increased or gradually decreased as the button region moves on the slide region from a minimum value in the numerical value range of the retrieval condition toward a maximum value therein.

It is preferable that the display control unit displays the button region on the display unit that changing the size of the button region, as the button region moves on the slide region from a minimum value in the numerical value range of the retrieval condition toward a maximum value therein through an intermediate value therein, so that the size of the button region is gradually increased between the minimum value and the intermediate value and is gradually decreased between the intermediate value and the maximum value, or the size of the button region is gradually decreased between the minimum value and the intermediate value and is gradually increased between the intermediate value and the maximum value.

It is preferable that the display control unit arranges, in a case where the number of the plurality of retrieval conditions is two, two slide regions corresponding to two retrieval conditions in a two-dimensional manner on the display unit for display.

It is preferable that the display control unit arranges, in a case where the number of the plurality of retrieval conditions is three, three slide regions corresponding to three retrieval conditions in a three-dimensional manner on the display unit for display.

It is preferable that the display control unit displays the button region on the display unit that changing a background color as the button region moves on the slide region.

It is preferable that the display control unit displays, while the button region is moving on the slide region, a numerical value corresponding to the position of the button region moving on the slide region on the display unit.

It is preferable that the display control unit further displays a numerical value corresponding to the position of a first button region on the display unit from the time when the first button region moves to the time when a second button region moves.

It is preferable that the display control unit changes positions where the slide regions and the button regions corresponding to the plurality of retrieval conditions are displayed on the display unit according to an instruction of the user.

It is preferable that the display control unit changes positions where the slide regions and the button regions corresponding to the plurality of retrieval conditions are displayed on the display unit according to a predetermined specific condition.

It is preferable that when the numerical value setting unit sets numerical values of the plurality of retrieval conditions, the display control unit displays, for each retrieval condition, the button region at a position on the slide region corresponding to a numerical value of the retrieval condition set the last time by the numerical value setting unit as an initial value of the numerical value of the retrieval condition.

It is preferable that the numerical value setting unit sets only the numerical value corresponding to the position of the button region on the slide region as the numerical value of the retrieval condition.

It is preferable that the numerical value setting unit sets a numerical value in a predetermined range including the numerical value corresponding to the position of the button region on the slide region as the numerical value of the retrieval condition.

It is preferable that the image retrieval condition setting device further comprises: a weight determination unit that determines a weight of the numerical value corresponding to the position of the button region on the slide region according to an order in which the position of the button region on the slide region is designated according to an instruction of the user, and the numerical value setting unit sets a numerical value weighted by the weight determined by the weight determination unit as the numerical value of the retrieval condition.

It is preferable that the display unit and the instruction acquisition unit is a touch panel that detects the intensity of a touch, the image retrieval condition setting device further comprises a weight determination unit that determines a weight of the numerical value corresponding to the position of the button region on the slide region according to the intensity of a touch with respect to the button region, and the numerical value setting unit sets a numerical value weighted by the weight determined by the weight determination unit as the numerical value of the retrieval condition.

It is preferable that the image retrieval condition setting device further comprises: a retrieval condition determination unit that determines the plurality of retrieval conditions.

It is preferable that the retrieval condition determination unit determines a plurality of retrieval conditions from retrieval conditions stored in advance in the image retrieval condition setting device as a default setting.

It is preferable that the retrieval condition determination unit determines at least one of the plurality of retrieval conditions determined as the default setting as a retrieval condition designated according to an instruction of the user.

It is preferable that the image retrieval condition setting device further comprises: a numerical value resetting unit that resets a numerical value of a retrieval condition corresponding to a button region designated according to an instruction of the user to a central value of a numerical value range of the retrieval condition corresponding to the designated button region.

It is preferable that the image retrieval condition setting device further comprises: a valid/invalid switching unit that performs switching between a valid state and an invalid state of a retrieval condition corresponding to a button region designated according to an instruction of the user.

It is preferable that the display control unit displays a line that connects only button regions corresponding to retrieval conditions in the valid state among plural button regions corresponding to the plurality of retrieval conditions on the display unit.

It is preferable that the display control unit displays a type of line set from a plurality of types of lines stored in advance in the image retrieval condition setting device on the display unit, as the line that connects only the button regions corresponding to the retrieval conditions in the valid state.

It is preferable that the display control unit sets, in a first line segment and a second line segment among two or more line segments that form the line connecting only the button regions corresponding to the retrieval conditions in the valid state, thicknesses of the line segments to be different from each other, and displays the button regions on the display unit.

It is preferable that the display control unit sets, in a button region corresponding to a retrieval condition in the valid state and a button region corresponding to a retrieval condition in the invalid state, display methods of the button regions to be different from each other, and displays the button regions on the display unit.

It is preferable that the display control unit sets, in a button region corresponding to a retrieval condition in the valid state and a button region corresponding to a retrieval condition in the invalid state, colors of the button regions to be different from each other, and displays the button regions on the display unit.

According to another aspect of the invention, there is provided an image retrieval apparatus comprising: the above-described image retrieval condition setting device; and an image retrieval unit that retrieves an image that matches a numerical value of a retrieval condition in the valid state set by the image retrieval condition setting device from the plurality of images, according to an instruction of the user, in which the display control unit displays at least a part of the images retrieved by the image retrieval unit on the display unit.

It is preferable that the image retrieval apparatus further comprises: a retrieval condition change unit that changes at least one of the plurality of retrieval conditions to a new retrieval condition in a case where a predetermined number of retrievals are performed in the retrieval condition in the valid state by the image retrieval unit, and the display control unit displays slide regions and button regions corresponding to the plurality of retrieval conditions changed by the retrieval condition change unit on the display unit.

It is preferable that the image retrieval apparatus further comprises: an advertisement determination unit that determines an advertisement to be proposed to the user in a case where an image is selected from the images retrieved by the image retrieval unit according to an instruction of the user, and the display control unit displays the advertisement determined by the advertisement determination unit on the display unit.

It is preferable that the advertisement determination unit determines a photo product created using the images selected by the user as the advertisement, according to the number of the images selected according to the instruction of the user.

It is preferable that the image retrieval apparatus further comprises: an image analysis unit that analyzes the image, and the advertisement determination unit determines a photo product created using the images selected by the user as the advertisement, according to an analysis result of the image analysis unit with respect to the images selected according to the instruction of the user.

According to still another aspect of the invention, there is provided an image retrieval condition setting method including: a step of acquiring an instruction input by a user, using an instruction acquisition unit; a step of determining, with respect to at least one of a plurality of retrieval conditions for retrieving an image from a plurality of images, a numerical value range of the retrieval condition according to the plurality of images, using a numerical value range determination unit; a step of displaying a slide region indicating the numerical value range of the retrieval condition on the display unit and displaying a button region that moves on the slide region on the display unit according to an instruction of the user, for each retrieval condition, using a display control unit; and a step of setting a numerical value corresponding to the position of the button region on the slide region from the numerical value range of the retrieval condition as the numerical value of the retrieval condition, for each retrieval condition, using a numerical value setting unit.

It is preferable that the image retrieval condition setting method further includes: a step of performing switching between a valid state and an invalid state of a retrieval condition corresponding to a button region designated according to an instruction of the user, using a valid/invalid switching unit.

It is preferable that the image retrieval condition setting method further includes: a step of displaying a line that connects only button regions corresponding to retrieval conditions in the valid state among plural button regions corresponding to the plurality of retrieval conditions on the display unit, using the display control unit.

According to still another aspect of the invention, there is provided a program that causes a computer to execute the respective steps of the above-described image retrieval condition setting method.

According to still another aspect of the invention, there is provided a computer-readable recording medium on which a program that causes a computer to execute the respective steps of the above-described image retrieval condition setting method is recorded.

According to still another aspect of the invention, there is provided an image retrieval method including: the respective steps of the above-described image retrieval condition setting method; a step of retrieving an image that matches a numerical value of a retrieval condition in the valid state set in the step of setting the numerical value of the retrieval condition from the plurality of images, according to an instruction of the user, using an image retrieval unit; and a step of displaying at least a part of the images retrieved by the image retrieval unit on the display unit, using the display control unit.

According to still another aspect of the invention, there is provided a program that causes a computer to execute the respective steps of the above-described image retrieval method.

According to still another aspect of the invention, there is provided a computer-readable recording medium on which a program that causes a computer to execute the respective steps of the above-described image retrieval method is recorded.

According to the invention, by sequentially setting numerical values of plural retrieval conditions using slide regions and button regions, it is possible to set numerical values of plural retrieval conditions for retrieving a user's desired image from a large number of images without input of numerical values or a text from a user. Thus, it is possible simply retrieve an image from plural images which are retrieval targets according to a user's request, using plural retrieval conditions.

Further, according to the invention, even in a case where plural images which are retrieval targets are changed, a numerical value range of each retrieval condition is automatically determined according to the plural images which are retrieval targets. In this way, according to the invention, by determining the numerical value range of each retrieval condition according to the plural images which are retrieval targets, a user can set each retrieval condition without being aware of the numerical value range of each retrieval condition.

### BRIEF DESCRIPTION OF THE DRAWINGS

FIG. 1 is a block diagram of an embodiment illustrating a configuration of an image retrieval apparatus of the invention.

FIG. 2 is a block diagram of an embodiment illustrating an image retrieval condition setting device shown in FIG. 1.

FIG. 3 is a conceptual diagram of an embodiment illustrating a configuration of a search screen.

FIG. 4 is a flowchart of an embodiment illustrating an operation of an image retrieval apparatus.

FIG. 5 is a conceptual diagram of another embodiment illustrating a configuration of a search screen.

FIG. 6 is a conceptual diagram of another embodiment illustrating a configuration of a search screen.

FIG. 7 is a conceptual diagram of an embodiment illustrating a state where images retrieved by an image retrieval unit are displayed on a display unit.

### DESCRIPTION OF THE PREFERRED EMBODIMENTS

Hereinafter, an image retrieval condition setting device, an image retrieval condition setting method, an image retrieval apparatus, an image retrieval apparatus, an image retrieval method, a program, and a recording medium of the invention will be described in detail based on preferred embodiments shown in the accompanying drawings.

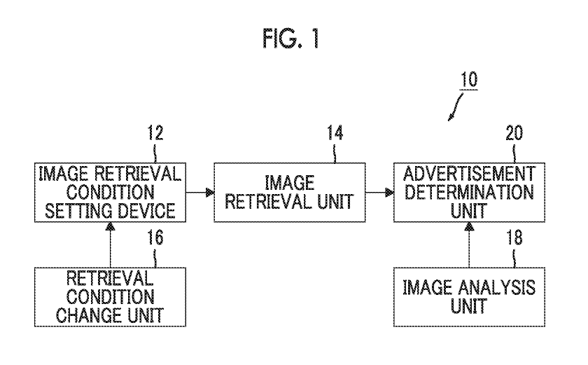

FIG. 1 is a block diagram of an embodiment illustrating a configuration of an image retrieval apparatus of the invention. An image retrieval apparatus 10 shown in FIG. 1 is an apparatus that retrieves an image that matches numerical values of plural retrieval conditions set according to a user's instructions from plural (a large number of) images stored in a smart phone, and comprises an image retrieval condition setting device 12, an image retrieval unit 14, a retrieval condition change unit 16, an image analysis unit 18, and an advertisement determination unit 20. One or more CPU (Central Processing Unit), which is not shown in the figure, performs as an image retrieval condition setting device 12, an image retrieval unit 14, a retrieval condition change unit 16, an image analysis unit 18, and an advertisement determination unit 20.

The retrieval conditions refer to conditions for retrieving an image desired by a user from plural images which are retrieval targets, and in this embodiment, five types of retrieval conditions including an imaging period, the number of figures, indoor/outdoor, an imaging distance, and an imaging time range are used.

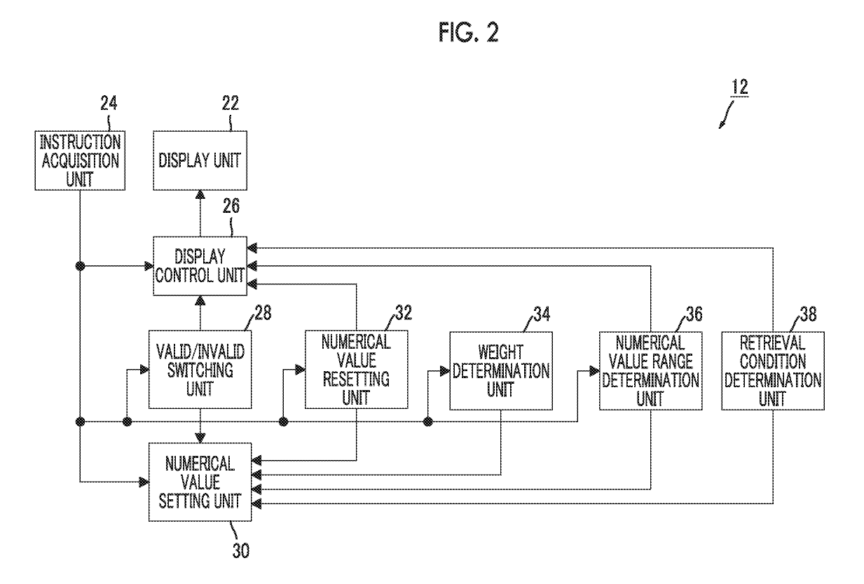

FIG. 2 is a block diagram of an embodiment illustrating an image retrieval condition setting device shown in FIG. 1. The image retrieval condition setting device 12 shown in FIG. 2 is a device that sets numerical values of plural retrieval conditions for retrieving a desired image from plural images, and comprises a display unit 22, an instruction acquisition unit 24, a display control unit 26, a valid/invalid switching unit 28, a numerical value setting unit 30, a numerical value resetting unit 32, a weight determination unit 34, a numerical value range determination unit 36, and a retrieval condition determination unit 38. One or more CPU, which is not shown in the figure, performs as a display control unit 26, a valid/invalid switching unit 28, a numerical value setting unit 30, a numerical value resetting unit 32, a weight determination unit 34, a numerical value range determination unit 36, and a retrieval condition determination unit 38.

In the image retrieval condition setting device 12, the display unit 22 is a unit that displays various images, for example, a search screen when retrieving an image, a retrieved image, or the like. The display unit 22 is a LCD (Liquid Crystal Display) for example.

Subsequently, the instruction acquisition unit 24 is a unit that acquires various instructions input by a user. The instruction acquisition unit 24 is a touch panel for example.

Although described later in detail, the user instructions include an instruction for displaying a search screen, an instruction for moving a button region on a slide region, an instruction for performing switching between a valid state and an invalid state for retrieval conditions, an instruction for resetting numerical values of a retrieval region, an instruction for changing display positions of a slide region and a button region corresponding to plural retrieval conditions, an instruction for determining types of retrieval conditions, an instruction for retrieving an image from plural images, or the like.

In the case of this embodiment, the display unit 22 and the instruction acquisition unit 24 are touch panels of a smart phone in which various images are displayed on a screen and a user performs a touch operation with respect to the screen to input a user's instruction.

Subsequently, the display control unit 26 that is a unit that performs a control for displaying various image on the display unit 22.

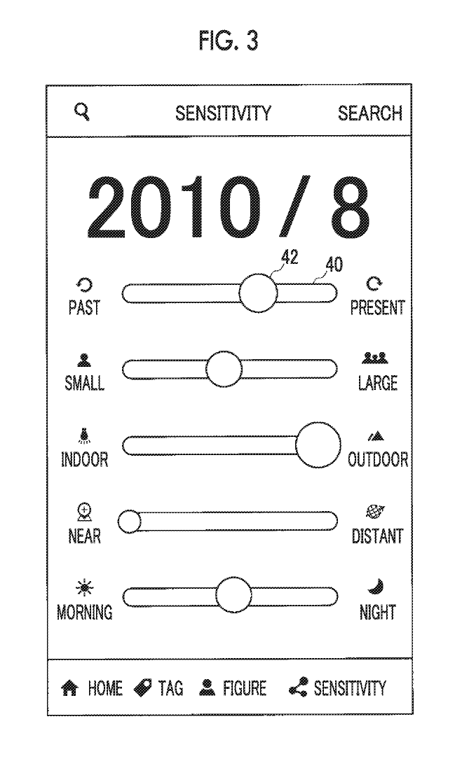

As shown in FIG. 3, on an image search screen, the display control unit 26 displays a slide region 40 indicating a numerical value range of the retrieval condition on the display unit 22, and displays a button region 42 that moves on the slide region 40 according to a user's instruction on the display unit 22, for each retrieval condition.

Although described later in detail, the display controls performed by the display control unit 26 include a control for displaying a line that connects only the button regions 42 corresponding to retrieval conditions in a valid state, a control for setting display methods of the button regions 42 to be different from each other for display, in the button regions 42 corresponding to the retrieval conditions in the valid state and the button regions 42 corresponding to retrieval conditions in an invalid state, a control for displaying numerical values of retrieval conditions corresponding to positions of the button regions 42, a control for displaying an image that matches plural retrieval conditions, a control for displaying an advertisement, or the like.

Subsequently, the valid/invalid switching unit 28 is a unit that performs switching between a valid state and an invalid state of retrieval conditions corresponding to the button regions 42 designated according to a user's instruction.

If retrieval conditions are in a valid state, image retrieval is performed using numerical values of the retrieval conditions, and if the retrieval conditions are in an invalid state, numerical values of the retrieval conditions are not used in image retrieval. That is, a user may determine whether to use each retrieval condition for image retrieval for each retrieval condition.

In the case of this embodiment, whenever a user touches the button region 42, the valid/invalid switching unit 28 performs switching between a valid state and an invalid state of a retrieval condition corresponding to the touched button region 42.

In a case where the valid state and the invalid state of the retrieval conditions are switched by the valid/invalid switching unit 28, the display control unit 26 sets display methods of the button regions 42 to be different from each other for display, in the button regions 42 corresponding to the retrieval conditions in the valid state and the button regions 42 corresponding to the retrieval conditions in the invalid state. In the case of this embodiment, the display control unit 26 sets colors of the button regions 42 to be different from each other for display, in the button regions 42 corresponding to the retrieval conditions in the valid state and the button regions 42 corresponding to the retrieval conditions in the invalid state.

Subsequently, the numerical value setting unit 30 is a unit that sets, for each retrieval condition, a numerical value corresponding to the position of the button region 42 on the slide region 40 from a numerical value range of the retrieval condition as a numerical value of the retrieval condition.

In this embodiment, if a user taps a retrieval button after determining a numerical value of each retrieval condition, the numerical value setting unit 30 sets a numerical value of a retrieval condition in a valid state.

The numerical value setting unit 30 may set only a numerical value corresponding to the position of the button region 42 on the slide region 40 as a numerical value of the retrieval condition, or may set a numerical value in a predetermined range including the numerical value corresponding to the position of the button region 42 on the slide region 40 as a numerical value of the retrieval condition. For example, in a case where a numerical value of the retrieval condition of the number of figures is 3, the numerical value setting unit 30 may set the numerical value of the number of figures to 3, or may set the numerical value of the number of figures to any one of 2 to 4, or to any one less than or equal to 3.

Then, the numerical value resetting unit 32 is a unit that resets a numerical value of a retrieval condition corresponding to the button region 42 designated according to a user's instruction as a central value in a numerical value range of the retrieval condition corresponding to the designated button region 42.

In the case of this embodiment, if a user double-taps the button region 42, the numerical value resetting unit 32 resets a numerical value of a retrieval condition corresponding to the double-tapped button region 42.

In a case where a numerical value of a retrieval condition is reset by the numerical value resetting unit 32, the display control unit 26 moves the button region 42 corresponding to the retrieval condition of which the numerical value is reset to a central position of the slide region 40 for display.

Subsequently, the weight determination unit 34 is a unit that determines a weight of a numerical value corresponding to the position of the button region 42 on the slide region 40 according to a user's instruction, that is, a weight of a numerical value corresponding to the position of the button region 42 on the slide region 40 according to a designation order of numerical values of retrieval conditions.

For example, the weight determination unit 34 may set a weight of a numerical value of a retrieval condition which is first determined to the heaviest value, and may gradually decrease weights of numerical values of retrieval conditions which are determined for the second time and thereafter. Contrarily, the weight determination unit 34 may set a weight of a numerical value of a retrieval condition which is first determined to the lightest value, and may gradually increase weights of numerical values of retrieval conditions which are determined for the second time and thereafter. Further, whether to gradually decrease or gradually increase weights of numerical values of retrieval conditions may be determined according to a user's instruction.

In addition, in the case of a touch panel that detects the intensity of a touch, the weight determination unit 34 may determine a weight of a numerical value corresponding to the position of the button region 42 on the slide region 40 according to the intensity of a touch corresponding to the button region 42. For example, if the intensity of the touch is equal to or greater than a threshold value, a weight of a numerical value may be increased, and if the intensity of the touch is smaller than the threshold value, the weight of the numerical value may be decreased. Contrarily, if the intensity of the touch is equal to or greater than a threshold value, a weight of a numerical value may be decreased, and if the intensity of the touch is smaller than the threshold value, the weight of the numerical value may be increased. Further, whether to decrease or increase the weight of the numerical value may be determined according to a user's instruction.

In a case where a weight of a numerical value corresponding to the position of the button region 42 on the slide region 40 is determined by the weight determination unit 34, the numerical value setting unit 30 sets a numerical value weighted by the weight determined by the weight determination unit 34 as a numerical value of a retrieval condition.

Subsequently, the numerical value range determination unit 36 is a unit that determines, with respect to at least one of plural retrieval conditions, a numerical value range of retrieval conditions according to plural images which are retrieval targets.

A numerical value range of each retrieval condition varies according to plural images which are retrieval targets. Thus, the numerical value range determination unit 36 determines a numerical value range of each retrieval condition according to plural images which are retrieval targets. For example, in a case where an imaging period of plural images which are retrieval targets is January, 2010 to December, 2010, the numerical value range determination unit 36 sets a numerical value range of a retrieval condition of the imaging period to January, 2010 to December, 2010.

Subsequently, the retrieval condition determination unit 38 is a unit that determines plural retrieval conditions used for image retrieval.

The retrieval condition determination unit 38 may determine plural retrieval conditions to be used for image retrieval from retrieval conditions stored in the image retrieval condition setting device 12 in advance, such as the above-described five types of retrieval conditions, as a default setting, for example. Further, the retrieval condition determination unit 38 may determine (change) at least one of the plural retrieval conditions determined as the default setting as a retrieval condition designated according to a user's instruction.

The invention is not limited to this embodiment, and it is sufficient if the number of retrieval conditions is 2 or greater. Further, the type of a specific retrieval condition may be arbitrarily determined. For example, whether hue is vivid or non-vivid, or whether brightness is bright or dark may be used.

If retrieval conditions are determined (changed) by the retrieval condition determination unit 38, the display control unit 26 displays the slide regions 40 and the button regions 42 corresponding to the plural retrieval conditions determined by the retrieval condition determination unit 38 on the display unit 22.

Subsequently, in the image retrieval apparatus 10, the image retrieval unit 14 is a unit that retrieves an image that matches a numerical value of a retrieval condition in a valid state set by the image retrieval condition setting device 12 from plural images which are retrieval targets according to a user's instruction.

In the case of this embodiment, if a user taps a retrieval button after determining a numerical value of each retrieval condition, the image retrieval unit 14 retrieves an image that matches a numerical value of a retrieval condition in a valid state set by the numerical value setting unit 30 from plural images which are retrieval targets.

In a case where an image is retrieved by the image retrieval unit 14, the display control unit 26 displays at least a part of images that are retrieved by the image retrieval unit 14 and match the retrieval condition in the valid state on the display unit 22.

Subsequently, the retrieval condition change unit 16 is a unit that changes, in a case where a predetermined number of retrievals are performed in a retrieval condition in a valid state by the image retrieval unit 14, at least one of plural retrieval conditions as a new retrieval condition.

In a case where a user cannot obtain a desired image although the user changes numerical values of respective retrieval conditions to perform a predetermined number of retrievals under the same plural retrieval conditions, even though the user further changes the numerical values of the respective retrieval conditions to perform retrieval, it is considered that it is difficult to obtain a user's desired image. In this case, the retrieval condition change unit 16 changes the retrieval conditions, to thereby make it possible to easily obtain a user's desired image.

In a case where the retrieval conditions are changed by the retrieval condition change unit 16, the display control unit 26 displays the slide regions 40 and the button regions 42 corresponding to the plural retrieval conditions changed by the retrieval condition change unit 16 on the display unit 22.

Subsequently, the image analysis unit 18 is a unit that analyzes an image.

The image analysis includes detection of imaging date and time of an image based on header information such as exchangeable image file format (Exif) information attached to the image and an imaging position (Global Positioning System (GPS) information); calculation of an imaging period of plural images which are retrieval targets; detection of a person who is present in an image and an object other than the person; calculation of the number of figures who are present in an image; determination of whether an image is captured indoor or outdoor; calculation of an imaging distance from a current position to an imaging position; detection of an imaging time range of an image, or the like, for example.

Then, the advertisement determination unit 20 is a unit that determines an advertisement to be proposed to a user in a case where an image is selected from images retrieved by the image retrieval unit 14 according to a user's instruction. The advertisement determination unit 20 determines an advertisement to be proposed to a user from advertisements stored in the server on the internet or user's smart phone.

The advertisement may be a simple message such as “Did you recently order a photo print?” regardless of an image selected according to a user's instruction. Further, according to the number of images selected by a user's instruction from images retrieved by the image retrieval unit 14, or according to an analysis result of the image analysis unit 18 with respect to an image selected according to a user's instruction, a photo product created using an image selected according to a user's instruction may be determined as an advertisement.

The photo product includes an electronic album, a photobook, a shuffle print, a postcard with a photo, a calendar with a photo, and the like, for example, in addition to a normal photo album.

In a case where an advertisement is determined by the advertisement determination unit 20, the display control unit 26 displays the advertisement determined by the advertisement determination unit 20 on the display unit 22.

Next, a search screen on which retrieval conditions are input when a user retrieves images will be described.

FIG. 3 is a conceptual diagram of an embodiment illustrating a configuration of a search screen. The search screen shown in FIG. 3 (sensitivity search screen) is divided into an instruction display region in an upper portion thereof, a retrieval condition display region in a central portion thereof, and a screen switching region in a lower portion thereof.

A magnifying glass button is displayed in a left part of the instruction input region, “sensitivity” indicating a sensitivity search screen is displayed in a central part thereof, and a retrieval button for instructing image retrieval is displayed in a right part thereof. In this embodiment, the term “sensitivity search” represents that it is possible to sensitively set a desired image retrieval condition according to a button position on a slide without requesting an input of a text or a numerical value. Thus, even though a search setting screen of this embodiment is referred to as the sensitivity search screen, the search setting screen may be referred to as another name.

In the case of this embodiment, in the retrieval condition display region, the slide regions 40 and the button regions 42 corresponding to five types of retrieval conditions including of an imaging period, the number of figures, indoor/outdoor, an imaging distance, and an imaging time range are displayed in a row in a vertical direction.

In the screen switching region, four tabs including home, tag, figure, and sensitivity for performing switching between a home screen, a tag search screen, a figure search screen, and a sensitivity search screen are displayed.

The magnifying glass button in the instruction input region is a button for displaying a designation screen for designating tag information, figures, or the like, as retrieval conditions, for example. However, since the designation screen is not in a direct relationship with the operation of this embodiment, description thereof will not be made. Further, four tabs in the screen switching region are displayed all the time regardless of a display screen. Similarly, since a home screen, a tag search screen, and a figure search screen are not in a direct relationship with the operation of this embodiment, description thereof will not be made. Hereinafter, the sensitivity search screen relating to this embodiment will be described.

On the sensitivity search screen, the slide region 40 that extends in a transverse direction of the search screen is displayed for each retrieval condition. That is, the button region 42 moves on the slide region 40 in the transverse direction of the search screen.

A user moves the button region 42 corresponding to a desired retrieval condition in the transverse direction of the search screen in a state of touching the button region 42 through a touch operation, to thereby make it possible to designate a numerical value of the desired retrieval condition.

The retrieval condition of the imaging period is a condition for designating a period of time for which an image is captured. In the case of this embodiment, the imaging period of the image may be changed in the unit of one month for designation.

For example, in a case where the imagine period of plural images which are retrieval targets is January, 2010 to December, 2010, a numerical value range of the retrieval condition of the imaging period is determined to January, 2010 to December, 2010 by the numerical value range determination unit 36.

If a user moves the button region 42 to “past” at the left end through a touch operation, a numerical value of the retrieval condition of the imaging period becomes January, 2010 (2010/1), and if the user moves the button region 42 to “present” at the right end, the numerical value of the retrieval condition of the imaging period becomes December, 2010 (2010/12). Further, when the user moves the button region 42 from the “past” at the left end to the “present” at the right end side, the numerical value of the retrieval condition of the imaging period is sequentially switched in the unit of one month from January, 2010 to December, 2010.

Subsequently, the retrieval condition of the number of figures is a condition for designating the number of figures who are present in an image as a numerical value. In the case of this embodiment, the number of figures may be switched in the unit of one person for designation.

For example, in a case where the number of figures who are present in plural images which are retrieval targets is 1 to 5, a numerical value range of the retrieval condition of the number of figures is determined as 1 to 5 by the numerical value range determination unit 36.

Similarly, if the user moves the button region 42 to “small” at the left end through a touch operation, a numerical value of the retrieval condition of the number of figures becomes 1, and if the user moves the button region 42 to “large” at the right end, the numerical value of the retrieval condition of the number of figures becomes 5. Further, when the user moves the button region 42 from the “small” at the left end to the “large” at the right end, the numerical value of the retrieval condition of the number of figures is sequentially switched from 1 to 5 in the unit of one person.

Subsequently, the retrieval condition of the indoor/outdoor is a condition for designating whether an image is captured indoor or outdoor as a numerical value thereof. In the case of this embodiment, any one of indoor and outdoor may be switchably designated. Determination of whether a certain image is an image captured indoor or outdoor may be performed by an appropriate method, for example, based on Exif information assigned in imaging (for example, it is considered that the image is captured outdoor when performing imaging in a scenery mode). Further, when the image has a predetermined brightness or higher in a predetermined number of pixels or more, it may be considered that the image is captured outdoor.

For example, in a case where plural images which are retrieval targets include images captured both indoor and outdoor, a numerical value range of the retrieval condition of the indoor/outdoor is determined as two values of indoor 0 and outdoor 1 by the numerical value range determination unit 36.

The numerical value range of the retrieval condition of the indoor/outdoor may be set at multiple levels according to the degree of indoor or outdoor, instead of two values of indoor 0 and outdoor 1.

Similarly, if the user moves the button region 42 to “indoor” at the left end through a touch operation, a numerical value of the retrieval condition of the indoor/outdoor becomes indoor, and if the user moves the button region 42 corresponding to the retrieval condition of the indoor/outdoor to “outdoor” at the right end, the numerical value of the retrieval condition of the indoor/outdoor becomes outdoor.

Subsequently, the retrieval condition of the imaging distance is a retrieval condition for designating a distance from a current position based on GPS information to an imaging position of an image based on Exif information as a numerical value thereof. In the case of this embodiment, an imaging distance of an image may be switchably designated in stages.

For example, in a case where an imaging distance between a current position and each of plural images which are retrieval targets is shorter than 50 km, a numerical value range of the retrieval condition of the imaging distance is determined to “shorter than 500 m”, “shorter than 1 km”, “shorter than 5 km”, “shorter than 10 km”, and “shorter than 50 km” by the numerical value range determination unit 36.

Similarly, if the user moves the button region 42 to “near” at the left end through a touch operation, a numerical value of the retrieval condition of the imaging distance becomes “shorter than 500 m”, and if the user moves the button region 42 to “distant” at the right end, the numerical value of the retrieval condition of the imaging distance becomes “shorter than 50 km”. When the user moves the button region 42 from the “near” at the left end to the “distant” at the right end, the numerical value of the retrieval condition of the imaging distance is sequentially switched in the order of “shorter than 500 m”, “shorter than 1 km”, “shorter than 5 km”, “shorter than 10 km”, and “shorter than 50 km”.

Instead of the above setting method, the retrieval condition of the imaging distance may be performed by a method for sequentially arranging distances between a current position and respective imaging positions of plural images which are retrieval targets from a short distance to a long distance, creating a group of distances for each predetermined distance range, and retrieving images in a group included in a predetermined distance range according to the position of the button region.

Subsequently, the retrieval condition of the imaging time range is a condition for designating a time range in which an image is captured as a numerical value thereof. In the case of this embodiment, an imaging time range of an image is switchably designated in the unit of one hour.

For example, in a case where imaging time ranges of plural images which are retrieval targets include all time ranges of 24 hours a day, a numerical value range of the retrieval condition of the imaging time range is determined from a time slot between 5:00 am and 6:00 am to a time slot between 4:00 am and 5:00 am by the numerical value range determination unit 36.

Similarly, if the user moves the button region 42 to “morning” at the left end through a touch operation, a numerical value of the retrieval condition of the imaging time range becomes “time slot between 5:00 am and 6:00 am”, and if the user moves the button region 42 to “night” at the right end, the numerical value of the retrieval condition of the imaging time range becomes “time slot between 4:00 am and 5:00 am”. Further, when the user moves the button region 42 from the “morning” at the left end to the “night” at the right end, the numerical value of the retrieval condition of the imaging time range is sequentially switched from “time slot between 5:00 am and 6:00 am” to “time slot between 4:00 am and 5:00 am” in the unit of one hour.

Further, when the button region 42 moves, a numerical value corresponding to the position of the button region 42 that moves on the slide region 40 is displayed in a numerical value display region in an upper part of the search screen by the display control unit 26 while the button region 42 is moving on the slide region 40. Further, a numerical value of a retrieval condition corresponding to the position of a first button region 42 is continuously displayed in the numerical value display region from the time when the first button region 42 moves to the time when a second button region 42 other than the first button region 42 moves.

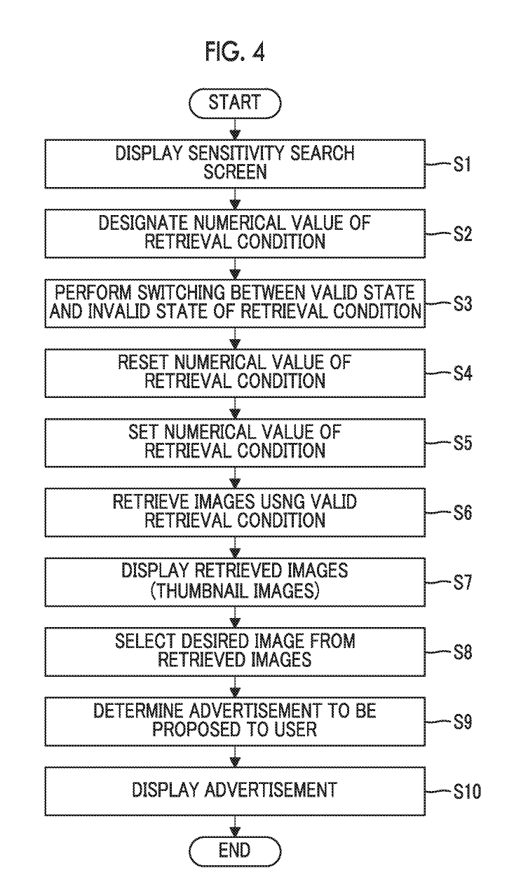

Next, an operation of the image retrieval apparatus 10 will be described with reference to a flowchart in FIG. 4.

In a case where image retrieval is performed, the sensitivity tag in the screen switching region displayed on the display unit 22 is tapped according to a touch operation of a user.

Accordingly, the user's instruction is acquired by the instruction acquisition unit 24 on the display control unit 26, and a search screen (sensitivity search screen) is displayed on the display unit 22 according to the user's instruction acquired by the instruction acquisition unit 24 (step S1).

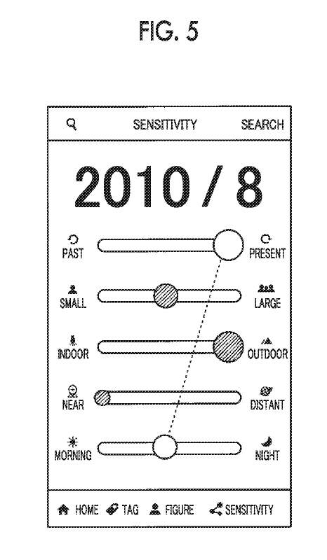

In the case of this embodiment, as shown in FIG. 5, only the retrieval conditions of the imaging period and the imaging time range among five types of retrieval conditions are in a valid state, and the retrieval conditions of the number of figures, the indoor/outdoor and the imaging distance are in an invalid state.

Further, a line that connects only the button regions 42 corresponding to the retrieval conditions of the imaging period and the imaging time range in the valid state, among the plural button regions 42 corresponding to the plural retrieval conditions, is displayed by the display control unit 26. Further, the display control unit 26 sets colors of the button regions 42 to be different from each other, in the button regions 42 corresponding to the retrieval conditions of the imaging period and the imaging time range in the valid state and the button regions 42 corresponding to the retrieval conditions of the number of figures, the indoor/outdoor and the imaging distance, and displays the button regions 42 on the display unit 22.

In this way, by displaying the line that connects only the button regions 42 corresponding to the retrieval conditions in the valid state, a user can intuitionally identify which sensitivity image retrieval is performed at first sight. Further, by setting the colors of the button regions 42 to be different from each other in the button regions 42 corresponding to the retrieval conditions in the valid state and the button regions 42 corresponding to the retrieval conditions in the invalid state, the user can intuitionally identify the valid state and the invalid state of the respective retrieval conditions at first sight.

Subsequently, in order to designate a numerical value of a retrieval condition for each retrieval condition, using a touch operation of a user, an instruction for moving the button region 42 corresponding to the retrieval condition is input (step S2).

Accordingly, the user's instruction is acquired by the instruction acquisition unit 24, and the button region 42 that moves on the slide region 40 is displayed by the display control unit 26 according to the user's instruction for each retrieval condition. Further, while the button region 42 is moving, a numerical value corresponding to the position of the button region 42 is displayed in a numerical value display region.

Further, the button region 42 corresponding to the retrieval condition of the number of figures in the invalid state is tapped by a user's touch operation, for example.

Accordingly, the user's instruction is acquired by the instruction acquisition unit 24, and the retrieval condition of the number of figures is switched to the valid state according to the user's instruction using the valid/invalid switching unit 28 (step S3).

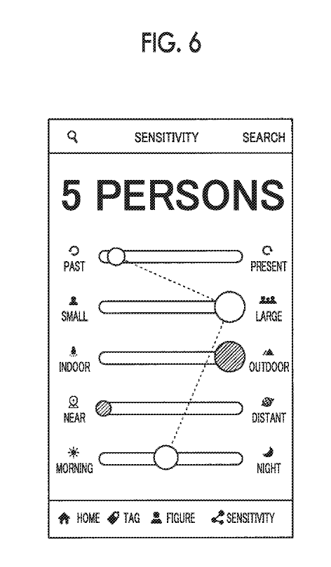

For example, if the retrieval condition of the number of figures is switched to the valid state, as shown in FIG. 6, a line that connects the button regions 42 corresponding to the retrieval conditions of the imaging period, the number of figures and the imaging time range in the valid state is displayed by the display control unit 26. Further, the color of the button region 42 corresponding to the retrieval condition of the number of figures in the valid state is changed from the color of the button region 42 corresponding to the retrieval condition in the invalid state to the color of the button region 42 corresponding to the retrieval condition of the number of figures in the valid state. Furthermore, while the button region 42 corresponding to the retrieval condition of the number of figures is moving on the slide region 40, a numerical value corresponding to the position of the button region 42 corresponding to the retrieval condition of the number of figures, which moves on the slide region 40, is displayed in the numerical value display region in the upper part of the search screen.

On the other hand, for example, if the button region 42 corresponding to the retrieval condition of the number of figures in the valid state is tapped by a user's touch operation, as shown in FIG. 5, the retrieval condition of the number of figures is switched to the invalid state by the valid/invalid switching unit 28.

This is similarly applied to a case where a valid state and an invalid state of another retrieval condition are switched.

Further, the button region 42 corresponding to the retrieval condition of the imaging period is double-tapped by a user's touch operation, for example.

Accordingly, the user's instruction is acquired by the instruction acquisition unit 24, and a numerical value of the retrieval condition of the imaging period is reset as a central value of a numerical value range of the retrieval condition of the imaging period according to the user's instruction, by the numerical value resetting unit 32 (step S4).

Designation of numerical values of respective retrieval conditions, switching between a valid state and an invalid state, and resetting of numerical values of retrieval conditions may be performed in an arbitrary order according to a user's designation.

Further, even in a case where there is a change in plural images which are retrieval targets, for example, even in a case where an image is added or deleted, the numerical value range determination unit 36 automatically determines numerical value ranges of the respective retrieval conditions according to the plural images which are retrieval targets. In this way, by automatically determining the numerical value ranges of the respective retrieval conditions according to the plural images which are retrieval targets, a user can set the respective retrieval conditions without being aware of the numerical value ranges of the respective retrieval conditions.

After designation of numerical values of five types of retrieval conditions is terminated, a retrieval button displayed in an instruction input region is tapped by a user's touch operation.

Accordingly, the user's instruction is acquired by the instruction acquisition unit 24, and a numerical value of a retrieval condition corresponding to the position of the button region 42 is set for each retrieval condition, by the numerical value setting unit 30 (step S5).

After the numerical value of the retrieval condition is set, an image that matches the numerical value of the retrieval condition in the valid state set by the numerical value setting unit 30 is retrieved from plural images which are retrieval targets, by the image retrieval unit 14 (step S6).

In this way, by sequentially setting numerical values of plural retrieval conditions using the slide region 40 and the button region 42, it is possible to set numerical values of plural retrieval conditions for retrieving a user's desired image from a large number of images without input of numerical values or text from a user. Thus, it is possible to simply retrieve an image from plural images which are retrieval targets according to a user's request, using plural retrieval conditions.

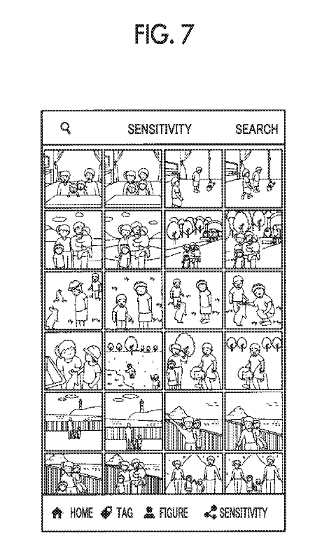

After the image retrieval is terminated, as shown in FIG. 7, images (thumbnail images) in the valid state that match the retrieval conditions, retrieved by the image retrieval unit 14, are displayed as a list on the display unit 22 by the display control unit 26 (step S7).

In the example of FIG. 7, only a predetermined number of images among the images retrieved by the image retrieval unit 14 are displayed on the display unit 22. In this case, a user may swipe an image display screen up and down, to thereby make it possible to sequentially display a predetermined number of arbitrary images on the display unit 22.

Subsequently, a desired image is selected from the images retrieved by the image retrieval unit 14 by a user's touch operation (step S8).

For example, by sequentially tapping desired images from the images displayed on the display unit 22, the desired images may be sequentially displayed.

Accordingly, the user's instruction is acquired by the instruction acquisition unit 24, for example, a new folder is created in a storage region of a smart phone, and an image selected by the user's instruction is classified into a newly created folder.

Further, a photo product generated using an image selected according to a user's instruction is determined as an advertisement to be proposed to a user, according to the number of images selected by a user's instruction, by the advertisement determination unit 20, for example (step S9).

For example, it may be determined that a message “Do you want to create an electronic album using selected images?” is to be proposed to a user as an advertisement.

Subsequently, the advertisement determined by the advertisement determination unit 20 is displayed on the display unit 22, by the display control unit 26 (step S10).

In this way, by displaying an advertisement, it is possible to propose creation of a photo product such as an electronic album using images selected by a user's instruction to a user, and to promote effective use images owned by the user.

The display control unit 26 may display one type of line set from plural types of lines stored in advance in the image retrieval condition setting device 12, including a dot line, a broken line, a solid line, a double-line, a wave line, or the like, on the display unit 22, as the line that connects only the button regions 42 corresponding to the retrieval conditions in the valid state. That is, the display control unit 26 may change the type of the line that connects only the button regions 42 corresponding to the retrieval conditions in the valid state according to settings.

Further, the display control unit 26 may set thicknesses of line segments, in a first line segment and a second line segment among two or more line segments that form the line that connects only the button regions 42 corresponding to the retrieval conditions in the valid state, and may display the button regions 42 on the display unit 22. For example, by setting the thickness of the first line segment to be larger than the thickness of the second line segment, two retrieval conditions corresponding to two button regions 42 connected by the thick first line segment may be emphasized for display.

In addition, when the button region 42 moves on the slide region40, the display control unit 26 may display the button region 42 on the display unit 22 while changing the size of the button region 42.

For example, when the button region 42 moves on the slide region 40 from a minimum value in a numerical value range of the retrieval condition toward a maximum value, the display control unit 26 may display the button region 42 on the display unit 22 while changing the size of the button region 42 so that the size of the button region is gradually increased or gradually decreased. Thus, the user can intuitionally identify a setting state of a numerical value of each retrieval condition at a sight.

Further, when the button region 42 moves on the slide region 40 from a minimum value in a numerical value range of a retrieval condition toward a maximum value therein through an intermediate value therein, the display control unit 26 may display the button region 42 on the display unit 22 while changing the size of the button region 42 so that the size of the button region 42 is gradually increased between the minimum value and the intermediate value and is gradually decreased between the intermediate value and the maximum value, or the size of the button region is gradually decreased between the minimum value and the intermediate value and is gradually increased between the intermediate value and the maximum value.

In addition, in a case where the number of plural retrieval conditions is two, the display control unit 26 may arrange two slide regions 40 corresponding to two retrieval conditions in a two-dimensional manner on the display unit 22 for display. Similarly, in a case where the number of plural retrieval conditions is three, the display control unit 26 may arrange three slide regions 40 corresponding to three retrieval conditions in a three-dimensional manner on the display unit 22 for display.

Further, when the button region 42 moves on the slide region 40, the display control unit 26 may display the button region 42 on the display unit 22 while changing a background color.

Furthermore, the display control unit 26 may change positions where the slide regions 40 and the button regions 42 corresponding to plural retrieval conditions are displayed on the display unit 22 according to a user's instruction. Further, the display control unit 26 may change positions where the slide regions 40 and the button regions 42 corresponding to plural retrieval conditions are displayed on the display unit 22 according to a predetermined specific condition, for example, priorities of retrieval conditions, use frequencies of retrieval conditions, preferences of retrieval conditions used by a user, or the like.

In addition, when the numerical value setting unit 30 sets numerical values of plural retrieval conditions, the display control unit 26 may display the button region 42 at a position on the slide region 40 corresponding to any one of a minimum value, an intermediate value, and a maximum value of a numerical value of a retrieval condition, for example, as an initial value of the numerical value of the retrieval condition, for each retrieval condition, or may display the button region 42 at a position on the slide region 40 corresponding to a numerical value of a retrieval condition set the last time by the numerical value setting unit as the initial value for each retrieval condition.

With respect to the image retrieval apparatus and the image retrieval condition setting device of the invention, an example in which images stored in a smart phone are retrieved is shown, but the invention is not limited thereto. The invention may be similarly applied to a case where images stored in a personal computer (PC), a notebook PC, a tablet PC, a server on cloud, or the like are retrieved.

In the apparatus and device of the invention, respective components included in the apparatus and device may be configured by dedicated hardware, or may be configured by a computer in which the respective components are programmed.

The methods of the invention may be performed by a program for causing a computer to execute respective steps. Further, a computer-readable recording medium on which such a program is recorded may be provided.

Hereinbefore, the invention has been described in detail, but the invention is not limited to the above-described embodiments, and may include various improvements and modifications in a range without departing from the concept of the invention.

### EXPLANATION OF REFERENCES

10: image retrieval apparatus
12: image retrieval condition setting device
14: image retrieval unit
16: retrieval condition change unit
18: image analysis unit
20: advertisement determination unit
22: display unit
24: instruction acquisition unit
26: display control unit
28: valid/invalid switching unit
30: numerical value setting unit
32: numerical value resetting unit
34: weight determination unit
36: numerical value range determination unit
38: retrieval condition determination unit
40: slide region
42: button region

What is claimed is:

1. An image retrieval condition setting device comprising:
a display unit;
an instruction acquisition unit that acquires an instruction input by a user;
a numerical value range determination unit that determines, with respect to at least one of a plurality of retrieval conditions for retrieving an image from a plurality of images, a numerical value range of the retrieval condition according to the plurality of images;
a display control unit that displays a slide region indicating the numerical value range of the retrieval condition on the display unit and displays a button region that moves on the slide region on the display unit according to an instruction of the user, for each retrieval condition; and
a numerical value setting unit that sets a numerical value corresponding to the position of the button region on the slide region from the numerical value range of the retrieval condition as the numerical value of the retrieval condition, for each retrieval condition.

2. The image retrieval condition setting device according to claim 1,
wherein the display control unit changes the size of the button region as the button region moves on the slide region.

3. The image retrieval condition setting device according to claim 2,
wherein the display control unit displays the button region on the display unit that changing the size of the button region so that the size of the button region is gradually increased or gradually decreased as the button region moves on the slide region from a minimum value in the numerical value range of the retrieval condition toward a maximum value therein.

4. The image retrieval condition setting device according to claim 2,
wherein the display control unit displays the button region on the display unit that changing the size of the button region, as the button region moves on the slide region from a minimum value in the numerical value range of the retrieval condition toward a maximum value therein through an intermediate value therein, so that the size of the button region is gradually increased between the minimum value and the intermediate value and is gradually decreased between the intermediate value and the maximum value, or the size of the button region is gradually decreased between the minimum value and the intermediate value and is gradually increased between the intermediate value and the maximum value.

5. The image retrieval condition setting device according to claim 1,
wherein the display control unit arranges, in a case where the number of the plurality of retrieval conditions is two, two slide regions corresponding to two retrieval conditions in a two-dimensional manner on the display unit for display.

6. The image retrieval condition setting device according to claim 1,
wherein the display control unit arranges, in a case where the number of the plurality of retrieval conditions is three, three slide regions corresponding to three retrieval conditions in a three-dimensional manner on the display unit for display.

7. The image retrieval condition setting device according to claim 1,
wherein the display control unit displays the button region on the display unit that changing a background color as the button region moves on the slide region.

8. The image retrieval condition setting device according to claim 1,
wherein the display control unit displays, while the button region is moving on the slide region, a numerical value corresponding to the position of the button region moving on the slide region on the display unit.

9. The image retrieval condition setting device according to claim 8,
wherein the display control unit further displays a numerical value corresponding to the position of a first button region on the display unit from the time when the first button region moves to the time when a second button region moves.

10. The image retrieval condition setting device according to claim 1,
wherein the display control unit changes positions where the slide regions and the button regions corresponding to the plurality of retrieval conditions are displayed on the display unit according to an instruction of the user.

11. The image retrieval condition setting device according to claim 1,
wherein the display control unit changes positions where the slide regions and the button regions corresponding to the plurality of retrieval conditions are displayed on the display unit according to a predetermined specific condition.

12. The image retrieval condition setting device according to claim 1,
wherein when the numerical value setting unit sets numerical values of the plurality of retrieval conditions, the display control unit displays, for each retrieval condition, the button region at a position on the slide region corresponding to a numerical value of the retrieval condition set the last time by the numerical value setting unit as an initial value of the numerical value of the retrieval condition.

13. The image retrieval condition setting device according to claim 1,
wherein the numerical value setting unit sets only the numerical value corresponding to the position of the button region on the slide region as the numerical value of the retrieval condition.

14. The image retrieval condition setting device according to claim 1,
wherein the numerical value setting unit sets a numerical value in a predetermined range including the numerical value corresponding to the position of the button region on the slide region as the numerical value of the retrieval condition.

15. The image retrieval condition setting device according to claim 1, further comprising:
a weight determination unit that determines a weight of the numerical value corresponding to the position of the button region on the slide region according to an order in which the position of the button region on the slide region is designated according to an instruction of the user,
wherein the numerical value setting unit sets a numerical value weighted by the weight determined by the weight determination unit as the numerical value of the retrieval condition.

16. The image retrieval condition setting device according to claim 1,
wherein the display unit and the instruction acquisition unit is a touch panel that detects the intensity of a touch,
wherein the image retrieval condition setting device further comprises a weight determination unit that determines a weight of the numerical value corresponding to the position of the button region on the slide region according to the intensity of a touch with respect to the button region, and
wherein the numerical value setting unit sets a numerical value weighted by the weight determined by the weight determination unit as the numerical value of the retrieval condition.

17. The image retrieval condition setting device according to claim 1, further comprising:
a retrieval condition determination unit that determines the plurality of retrieval conditions.

18. The image retrieval condition setting device according to claim 17,
wherein the retrieval condition determination unit determines a plurality of retrieval conditions from retrieval conditions stored in advance in the image retrieval condition setting device as a default setting.

19. The image retrieval condition setting device according to claim 18,
wherein the retrieval condition determination unit determines at least one of the plurality of retrieval conditions determined as the default setting as a retrieval condition designated according to an instruction of the user.

20. The image retrieval condition setting device according to claim 1, further comprising:
a numerical value resetting unit that resets a numerical value of a retrieval condition corresponding to a button region designated according to an instruction of the user to a central value of a numerical value range of the retrieval condition corresponding to the designated button region.

21. The image retrieval condition setting device according to claim 1, further comprising:
a valid/invalid switching unit that performs switching between a valid state and an invalid state of a retrieval condition corresponding to a button region designated according to an instruction of the user.

22. The image retrieval condition setting device according to claim 21,
wherein the display control unit displays a line that connects only button regions corresponding to retrieval conditions in the valid state among plural button regions corresponding to the plurality of retrieval conditions on the display unit.

23. The image retrieval condition setting device according to claim 22,
wherein the display control unit displays a type of line set from a plurality of types of lines stored in advance in the image retrieval condition setting device on the display unit, as the line that connects only the button regions corresponding to the retrieval conditions in the valid state.

24. The image retrieval condition setting device according to claim 22,
wherein the display control unit sets, in a first line segment and a second line segment among two or more line segments that form the line connecting only the button regions corresponding to the retrieval conditions in the valid state, thicknesses of the line segments to be different from each other, and displays the button regions on the display unit.

25. The image retrieval condition setting device according to claim 21,
wherein the display control unit sets, in a button region corresponding to a retrieval condition in the valid state and a button region corresponding to a retrieval condition in the invalid state, display methods of the button regions to be different from each other, and displays the button regions on the display unit.

26. The image retrieval condition setting device according to claim 25,
wherein the display control unit sets, in a button region corresponding to a retrieval condition in the valid state and a button region corresponding to a retrieval condition in the invalid state, colors of the button regions to be different from each other, and displays the button regions on the display unit.

27. An image retrieval apparatus comprising:
the image retrieval condition setting device according to claim 21; and
an image retrieval unit that retrieves an image that matches a numerical value of a retrieval condition in the valid state set by the image retrieval condition setting device from the plurality of images, according to an instruction of the user,
wherein the display control unit displays at least a part of the images retrieved by the image retrieval unit on the display unit.

28. The image retrieval apparatus according to claim 27, further comprising:
a retrieval condition change unit that changes at least one of the plurality of retrieval conditions to a new retrieval condition in a case where a predetermined number of retrievals are performed in the retrieval condition in the valid state by the image retrieval unit,
wherein the display control unit displays slide regions and button regions corresponding to the plurality of retrieval conditions changed by the retrieval condition change unit on the display unit.

29. The image retrieval apparatus according to claim 27, further comprising:
an advertisement determination unit that determines an advertisement to be proposed to the user in a case where an image is selected from the images retrieved by the image retrieval unit according to an instruction of the user,
wherein the display control unit displays the advertisement determined by the advertisement determination unit on the display unit.

30. The image retrieval apparatus according to claim 29,
wherein the advertisement determination unit determines a photo product created using the images selected by the user as the advertisement, according to the number of the images selected according to the instruction of the user.

31. The image retrieval apparatus according to claim 29, further comprising:
an image analysis unit that analyzes the image,
wherein the advertisement determination unit determines a photo product created using the images selected by the user as the advertisement, according to an analysis result of the image analysis unit with respect to the images selected according to the instruction of the user.

32. An image retrieval condition setting method comprising:
a step of acquiring an instruction input by a user, using an instruction acquisition unit;
a step of determining, with respect to at least one of a plurality of retrieval conditions for retrieving an image from a plurality of images, a numerical value range of the retrieval condition according to the plurality of images, using a numerical value range determination unit;
a step of displaying a slide region indicating the numerical value range of the retrieval condition on the display unit and displaying a button region that moves on the slide region on the display unit according to an instruction of the user, for each retrieval condition, using a display control unit; and
a step of setting a numerical value corresponding to the position of the button region on the slide region from the numerical value range of the retrieval condition as the numerical value of the retrieval condition, for each retrieval condition, using a numerical value setting unit.

33. The image retrieval condition setting method according to claim 32, further comprising:
a step of performing switching between a valid state and an invalid state of a retrieval condition corresponding to a button region designated according to an instruction of the user, using a valid/invalid switching unit.

34. The image retrieval condition setting method according to claim 33, further comprising:
a step of displaying a line that connects only button regions corresponding to retrieval conditions in the valid state among plural button regions corresponding to the plurality of retrieval conditions on the display unit, using the display control unit.

35. A non-transitory computer-readable recording medium on which a program that causes a computer to execute the respective steps of the image retrieval condition setting method according to claim 32 is recorded.

36. An image retrieval method comprising:
the respective steps of the image retrieval condition setting method according to claim 33;
a step of retrieving an image that matches a numerical value of a retrieval condition in the valid state set in the step of setting the numerical value of the retrieval condition from the plurality of images, according to an instruction of the user, using an image retrieval unit; and
a step of displaying at least a part of the images retrieved by the image retrieval unit on the display unit, using the display control unit.

37. A computer-readable recording medium on which a program that causes a computer to execute the respective steps of the image retrieval method according to claim 36 is recorded.
